(19) United States
(12) Patent Application Publication
(10) Pub. No.: US 2014/0136578 A1
(43) Pub. Date: May 15, 2014

(54) TECHNIQUES TO MANAGE VIRTUAL FILES

(71) Applicant: MICROSOFT CORPORATION, Redmond, WA (US)

(72) Inventors: Matthew Wood, Sammamish, WA (US); Robert A. Little, Redmond, WA (US); Jonathan Becket Bailor, Bellevue, WA (US)

(73) Assignee: Microsoft Corporation, Redmond, WA (US)

(21) Appl. No.: 13/678,257

(22) Filed: Nov. 15, 2012

(51) Int. Cl. G06F 17/30

(52) U.S. Cl. 707/821; 707/E17.01

(57) ABSTRACT

Techniques to manage virtual files are described. An apparatus may comprise a processor circuit and a virtual file application operative on the processor circuit to manage file operations for a virtual file, the virtual file comprising a set of calls to one or more file services arranged to manage file information for the virtual file, the file information comprising a content block or content block instructions for a content block associated with the virtual file. Other embodiments are described and claimed.

### BACKGROUND

An application typically accesses information stored in an electronic file. An electronic file is a data structure that stores a set of information in a persistent and organized manner. Different applications typically utilize different file formats. For instance, a word processing application may store a document in a word processing format, a spreadsheet application may store a document in a spreadsheet format, and so forth. In most instances, a file format and content for an electronic file remains static unless manually modified by a user. The static nature of electronic files makes it difficult to perform some automated file operations. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to manage virtual files. Some embodiments are particularly directed to techniques to manage virtual files for an application in a dynamic and flexible manner. In one embodiment, for example, an apparatus may comprise a processor circuit and a virtual file application. The virtual file application may be operative on the processor circuit to manage file operations for a virtual file. The virtual file may comprise a set of calls, references or pointers to one or more file services arranged to manage file information for the virtual file. The file information may comprise a content block or content block instructions for a content block associated with the virtual file. By storing calls to file services rather than actual content blocks and content block instructions, modifications may be automatically made to the content blocks and the content block instructions using a service architecture, such as a service oriented architecture (SOA). Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a file system.

FIG. 2 illustrates an embodiment of a virtual file for a file system.

FIG. 3 illustrates an embodiment of a file service provider for a file system.

FIG. 4 illustrates an embodiment of a logic flow for the file system of FIG. 1.

FIG. 5A illustrates an embodiment of a logic flow for a write operation of the file system of FIG. 1.

FIG. 5B illustrates an embodiment of a logic flow for a write file service of the file system of FIG. 1.

FIG. 6A illustrates an embodiment of a logic flow for a read operation of the file system of FIG. 1.

FIG. 6B illustrates an embodiment of a logic flow for a read file service of the file system of FIG. 1.

FIG. 7 illustrates an embodiment of a logic flow for translating a virtual file of the file system of FIG. 1.

FIG. 8 illustrates an embodiment of a centralized system for the file system of FIG. 1.

FIG. 9 illustrates an embodiment of a distributed system for the file system of FIG. 1.

FIG. 10 illustrates an embodiment of a sample computing architecture.

FIG. 11 illustrates an embodiment of a sample communications architecture.

### DETAILED DESCRIPTION

Software architectures are increasingly starting to move towards a services model. Often a client application may be designed to utilize features provided by a software service executing on a server. Web services and technologies are one prominent example of this migration. However, a design challenge remains in that client-side applications typically utilize electronic files that revolve around fixed file formats while server-side services revolve around fluid and discrete operations. The static nature of electronic files conflicts with the dynamic nature of services. With the movement towards cloud computing, client applications and server based services are starting to merge into similar architectures. As the line between client applications and services blurs, the definition of a “file format” for an electronic file also begins to blur. As such there is a need to modify electronic files to conform to changes in software architectures.

Embodiments provide techniques for creating, modifying and managing new types of electronic file suitable for heterogeneous client and server applications which are designed to fulfill a need for applications to utilize fixed file formats and simultaneously a need for file services to perform fluid and discrete operations.

Embodiments introduce a novel paradigm for electronic files, file formats for electronic files, and client-server interactions involving electronic files. Historically, a file format was defined as a set of content and a set of instructions indicating what a client application should do with that content. Embodiments have reimagined a file format for an electronic file that is defined as a set of abstractions, such as a set of calls a client application can make to one or more file services. The file services then provide content and instructions for the client application. As such, an electronic file becomes an abstraction layer between a client application and a set of file services that host content and content instructions for the client application. This allows modifications to both client-side and server-side operations without needing to constantly make modifications to an actual electronic file. Furthermore, such modifications can be made automatically or programmatically without manual interaction with an electronic file.

Various embodiments are directed to a new construct referred to herein as a “virtual file.” In general, a virtual file may comprise a container with program code or instructions suitable for use as an interface between an application and a set of services. Unlike conventional electronic files, a virtual file typically does not store actual content or content instructions. Rather, a virtual file may comprise a set of calls, references, interfaces, pointers or other software construct that enables an application to interoperate with one or more file services. The one or more file services are arranged to manage file information referenced in the virtual file.

Since a virtual file does not contain actual content or content instructions, the virtual file does not need to necessarily adhere to an application file format that is proprietary to a given client application. Rather, a virtual file may have a uniform data schema that may be used across multiple types of applications. However, a virtual file may be translated to a given application file format when needed utilizing a file translator as described further below.

Virtual files may offer several advantages over conventional electronic files. For instance, virtual files offer a greater degree of flexibility, robustness, and dynamism relative to electronic files. As a result, the embodiments can improve affordability, scalability, modularity, extendibility, or interoperability for an operator, device or network.

One major advantage of virtual files is that they provide nearly infinite flexibility in terms of data management. Content for electronic files may be managed by a file service, and returned to a client application when needed. This allows application content to take advantage of the robust features offered by a service. Unlike conventional electronic files, where content remains static, content managed by a file service may be dynamically modified with little if any need to modify the virtual file itself. Furthermore, content transmitted to a client application is completely “tunable” to an environment for the client application. For instance, a set of capabilities parameters may be sent to a file service. The file service may modify its managed content based on the capabilities parameters. For instance, the file service may return content modified to adapt to variations in computing platforms for a client, such as processor type, processor power, memory resources, input/output (I/O) devices, and so forth. Returned content may also be modified to adapt to variations in communications systems, such as protocols, latency, bandwidth, traffic, medium, type and so forth. Returned content may further be modified to adapt to variations in a file service provider platform which provides the actual file services. For example, if a file service provider platform is a computing platform for a server returned content may be modified in accordance with differences in server loads, server availability, server applications, server database structures, and so forth. This can provide dramatic enhancements in performance as well as unlocking a myriad number of features for a client application.

Another major advantage of virtual files relative to conventional electronic files is the dynamic nature of virtual files. A virtual file may comprise a file format representing a set of abstractions which are defined by a given service. As such, content managed and provided by a file service to a client application may comprise “fresh” or up-to-date content retrievable by the file service. This can lead to client applications providing a host of new features directed to updated content, while simultaneously continuing to offer all of the traditional features typically provided by the client applications.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

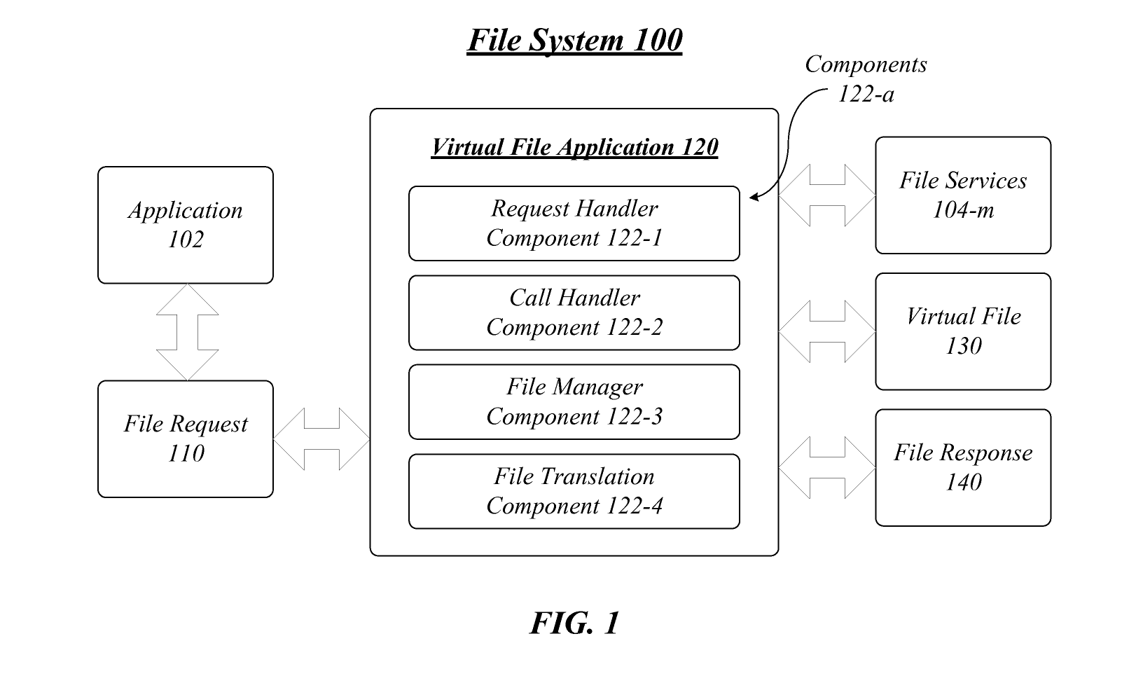

FIG. 1 illustrates a block diagram for a file system 100. In one embodiment, the file system 100 may comprise a computer-implemented file system 100 having a virtual file application 120 comprising one or more components 122-a. Although the file system 100 shown in FIG. 1 has a limited number of elements in a certain topology, it may be appreciated that the file system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

The file system 100 may comprise an application 102. The application 102 may comprise any software application capable of creating, modifying, managing or otherwise using an electronic file. In one embodiment, the application 102 may comprise or be implemented as a productivity application. A productivity application may comprise a software application program designed to perform a specific set of functions for a knowledge worker. A productivity application typically operates to create, modify, send, receive, or otherwise manage content for one or more documents. Examples for productivity applications may include without limitation a productivity suite of inter-related client applications, server applications and web services, designed for a particular operating system, such as a MICROSOFT® OFFICE productivity suite for MICROSOFT WINDOWS®, made by Microsoft Corporation, Redmond, Wash. Examples for productivity applications may include without limitation MICROSOFT WORD, MICROSOFT EXCEL®, MICROSOFT POWERPOINT®, MICROSOFT OUTLOOK®, MICROSOFT ACCESS®, MICROSOFT INFOPATH®, MICROSOFT ONENOTE®, MICROSOFT PROJECT, MICROSOFT PUBLISHER, MICROSOFT SHAREPOINT® WORKSPACE, MICROSOFT VISIO®, MICROSOFT OFFICE INTERCONNECT, MICROSOFT OFFICE PICTURE MANAGER, MICROSOFT SHAREPOINT DESIGNER, and MICROSOFT LYNC. Examples for server applications may include without limitation MICROSOFT SHAREPOINT SERVER, MICROSOFT LYNC SERVER, MICROSOFT OFFICE FORMS SERVER, MICROSOFT OFFICE GROOVE® SERVER, MICROSOFT OFFICE PROJECT SERVER, MICROSOFT OFFICE PROJECT PORTFOLIO SERVER, and MICROSOFT OFFICE PERFORMANCEPOINT® SERVER. Examples for web services may include without limitation MICROSOFT WINDOWS LIVE®, MICROSOFT OFFICE WEB APPLICATIONS, MICROSOFT OFFICE LIVE, MICROSOFT LIVE MEETING, MICROSOFT OFFICE PRODUCT WEB SITE, MICROSOFT UPDATE SERVER, and MICROSOFT OFFICE 365. It also is to be appreciated that embodiments may implement other types of applications in addition to productivity applications which are consistent with the described embodiments. The embodiments are not limited to these examples.

The application 102 is arranged to interoperate with a virtual file application 120 and is one consumer of services provided by file services 104-m. The application 102 utilizes a specialized form of electronic files, such as one or more virtual files 130. The application 102 may be used to generate and manipulate content and content instructions that appear to be “stored” in a virtual file 130, where in actuality the content and content instructions are stored by one or more file services 104-m and accessed via a set of interfaces provided by the virtual file 130. In this sense the virtual file 130 operates as an abstraction layer between the application 102 and the file services 104-m.

The file system 100 may comprise the virtual file application 120. The virtual file application 120 may be generally arranged to operate as a file manager designed to manage file operations for one or more virtual files 130. The virtual file application 120 may manage various types of file operations for a virtual file 130, such as creating a virtual file 130, writing to a virtual file 130, reading from a virtual file 130, copying a virtual file 130, moving a virtual file 130, and other file operations typically performed on conventional electronic files. In one embodiment, the virtual file application 120 may be a stand-alone application designed to interoperate with the application 102. In one embodiment, the virtual file application 120 may be integrated with the application 102. In one embodiment, the virtual file application 120 may be integrated with another application accessible by the application 102, such as a system program (e.g., an operating system), for example.

In various embodiments, the virtual file application 120 may comprise program code designed to interoperate, manipulate and manage any software constructs contained within a virtual file 130. In one embodiment, for example, a virtual file 130 may utilize software constructs manifested as a set of calls to one or more file services 104-m arranged to manage file information for the virtual file 130. Although some embodiments utilize “calls” by way of example and not limitation, it may be appreciated that a virtual file 130 may utilize any software construct that operates as a suitable interface between the application 102 and the file services 104-m. The embodiments are not limited in this context.

In various embodiments, a “call” may refer to a discrete set of program code designed to allow a program to request a service from another program. Examples of programs providing a service may include an application, subroutine, procedure, function, routine, method, subprogram, and so forth. The programs providing a service may be on a local (e.g., client device) or remote machine (e.g., server device). For instance, a system call may be used to request service from an operating system or another application program. Here, the application 102 may be capable of executing a call in a virtual file 130 to services provided by file services 104-m. In this capacity, the application 102 may be considered a “caller” while a file service 104-1, 104-2 . . . 104-m may be considered a “called service.” When making a call, the application 102 may include one or more data values, sometimes referred to as input parameters or arguments, that can be passed to the file service 104-m. Similarly, a call may also return one or more data values, sometimes referred to as output parameters or return values, that can be passed from the file service 104-m to the application 102. A called service (e.g., file service 104-m) may be provided by a same application as a caller program (e.g., application 102), by a different application from the caller program, or some combination of both. A called service may also execute within a same computing device as a caller program, in a different computing device from the caller program, or some combination of both. When a caller program and a called service are different processes, remote techniques such as remote procedure call (RPC) may be used. A RPC is an inter-process communication that allows a computer program to cause a subroutine or procedure to execute in another address space (commonly on another computer on a shared network) without the caller program needing explicitly coding for this remote interaction. When object-oriented programming techniques are used, RPC is sometimes referred to as remote invocation or remote method invocation.

In various embodiments, the application 102 and/or the virtual file application 120 may manage calls stored in a virtual file 130 to one or more file services 104-m. A file service 104-m may provide a set of related and well defined software functionalities that can be accessed using a prescribed interface and is exercised consistent with constraints and policies as specified by a service description. A service description provides a detailed definition typically supported by a process model, and may include machine-readable semantic information about the service that facilitate service mediation and consistency checking in a distributed computing architecture, a set of performance parameters, and/or a service model indicating the types of information provided by the service. An example of a file service 104-m may include a web service which utilizes web technologies to provide a set of software functionalities via a web browser. Another example of a file service 104-m may include services associated with a service-oriented architecture (SOA), which is a set of principles and methodologies for designing and developing software in the form of interoperable services. Embodiments may utilize any type of software services, and are not limited to these examples.

In various embodiments, a file service 104-m may manage one or more content blocks for the application 102 and/or a virtual file 130. A content block may comprise any discrete set of multimedia information accessible by the application 102 and suitable for storage in an electronic file. A content block may have any size, granularity, or delimiters desired for a given implementation. A content block may vary based on a type of application 102. For instance, when the application 102 is implemented as a word processing application, a content block may comprise a set of content from a word processing document (e.g., text, page, image, table, etc.). When the application 102 is implemented as a spreadsheet application, a content block may comprise a set of content from a spreadsheet document (e.g., a cell, a workbook, a graph, a pivot table, etc.). The embodiments are not limited in this context.

In various embodiments, a file service 104-m may manage one or more content block instructions for the application 102 and/or a virtual file 130. A content block instruction may comprise any control information for a content block that is accessible by the application 102 and suitable for storage in an electronic file. A content block instruction may vary based on a type of application 102. For instance, when the application 102 is implemented as a word processing application, a content block instruction for a content block may comprise a set of formatting or layout instructions for multimedia information found in a word processing document (e.g., bold, underline, columns, etc.). When the application 102 is implemented as a spreadsheet application, a content block instruction for a content block may comprise a set of formatting or layout instructions found in a spreadsheet document (e.g., formulas, equations, references, etc.). The embodiments are not limited in this context.

The virtual file application 120 may comprise multiple components 122-a. As shown in FIG. 1, the virtual file application 120 may comprise a request handler component 122-1. The request handler component 122-1 may be generally arranged to manage file requests 110 and file responses 140 for a virtual file 130. A file request 110 may be a request for a file operation on the virtual file 130, such as create, modify, read, write, copy, move, lock, and so forth. A file response 140 may indicate completion of a file operation, or returning results from a file operation, as indicated by the file request 110. An application 102 may generate and send a file request 110 to the virtual file application 120. The application 102 may also receive and process a file response 140 from the virtual file application 120.

The virtual file application 120 may also comprise a call handler component 122-2. The call handler component 122-2 may be generally arranged to manage a set of calls for a virtual file 130. As previously described, a virtual file 130 may comprise a set of calls to one or more file services 104-m arranged to manage file information for the virtual file 130. File information may comprise a content block or content block instructions for a content block associated with the virtual file 130.

The virtual file application 120 may further comprise a file manager component 122-3. The file manager component 122-3 may be generally arranged to perform various file operations for a virtual file 130. Examples of file operations may include any known file operations, such as create, modify, read, write, copy, move, lock, unlock, set versions, set permissions, and so forth. Examples of file operations may further include new file operations made possible by a virtual file 130. As previously discussed, the use of virtual file 130 allows content to be transmitted to application 102 in a manner that is completely customized for an environment of the application 102. As such, new file operations may include without limitation returning content adapted to variations in computing platforms for the application 102 (e.g., processor type, processor power, memory resources, input/output (I/O) devices, and so forth), returning content adapted to variations in communications systems (e.g., protocols, latency, bandwidth, traffic, medium, type and so forth), returning content adapted to variations in a file service provider platform which provides file services (e.g., server type, server loads, server availability, server applications, server database structures, and so forth), returning updated or “fresh” content, among other types of new file operations. The embodiments are not limited in this context.

The virtual file application 120 may also comprise a file translation component 122-4. The file translation component 122-4 may be generally arranged to translate file information for a virtual file 130 into a given application file format for the application 102. The use of a virtual file 130 liberates the need of having a defined file format for every type of application 102. In some cases, however, it may be desirable to utilize a fixed file format suitable to a given type of application 102. In such cases, the file translation component 122-4 may retrieve an application file format model appropriate for a given application 102, and translate a virtual file 130 from a set of calls into a set of content blocks and content block instructions stored in a data schema specified by the application 102 in accordance with the application file format model. In this manner, a virtual file 130 may be translated or converted into a conventional electronic file fully compatible with legacy file operations used by the application 102.

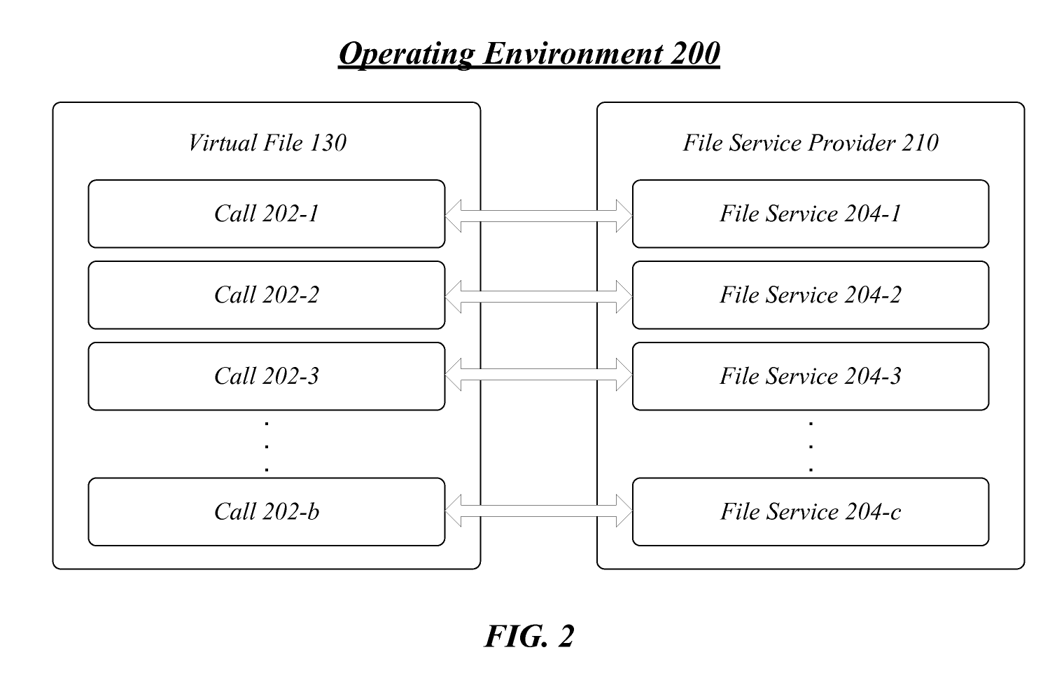

FIG. 2 illustrates an embodiment of an operational environment 200 for the file system 100. More particularly, FIG. 2 illustrates an exemplary mapping between a set of calls 202-b for a virtual file 130 and a corresponding set of file services 204-c provided by one or more file service providers 210. The file services 204-c may be representative of, for example, the file services 140-m.

As shown in FIG. 2, the virtual file 130 may comprise a set of one or more calls 202-b, which are programmatic interfaces to services provided by the corresponding file services 204-c. The file service provider 210 may be on a same or different machine as the virtual file 130 and/or the application 102. Although FIG. 2 illustrates a one-to-one correspondence between a call 202-b and a file service 204-c, it may be appreciated that a one-to-many, many-to-one, or many-to-many configuration may be implemented as well. The embodiments are not limited in this context.

Each of the calls 202-b may be configured for a corresponding file service 204-c to manage content blocks and content block instructions for a virtual file 130 with any desired level of granularity.

In one embodiment, a single call 202-b may be to a single file service 204-c that manages any type of content block and content block instructions for the virtual file 130. For instance, a single call 202-1 may be to a single file service 204-1 that manages all types of content blocks and content block instructions for the virtual file 130.

In one embodiment, each call 202-b may be to a file service 204-c that manages a specific type of content block and content block instructions for the virtual file 130. For example, a call 202-1 and a file service 204-1 may be customized to handle content blocks of type text, a call 202-2 and a file service 204-2 may be customized to handle content blocks of type image, a call 202-3 and a file service 204-3 may be customized to handle content blocks of type table, and so forth.

In one embodiment, each call 202-b may be to a multiple file services 204-c that manages different types of file operations for the virtual file 130. For example, a call 202-1 and a file service 204-1 may be customized to handle write operations, a call 202-2 and a file service 204-2 may be customized to handle read operations, a call 202-3 and a file service 204-3 may be customized to handle lock operations, and so forth.

In one embodiment, each call 202-b may be to a multiple file services 204-c that manages different content blocks and content block instructions for the virtual file 130. For example, a call 202-1 and a file service 204-1 may be customized to handle a first content block (e.g., a first paragraph of a word processing document), a call 202-2 and a file service 204-2 may be customized to handle a second content block (e.g., a second paragraph of a word processing document), a call 202-3 and a file service 204-3 may be customized to handle a third content block (e.g., a third paragraph of a word processing document), and so forth.

It may be appreciated that these are merely a few examples of topology that may be designed utilizing the calls 202-b and the file services 204-c, and others are possible as well. The embodiments are not limited in this context.

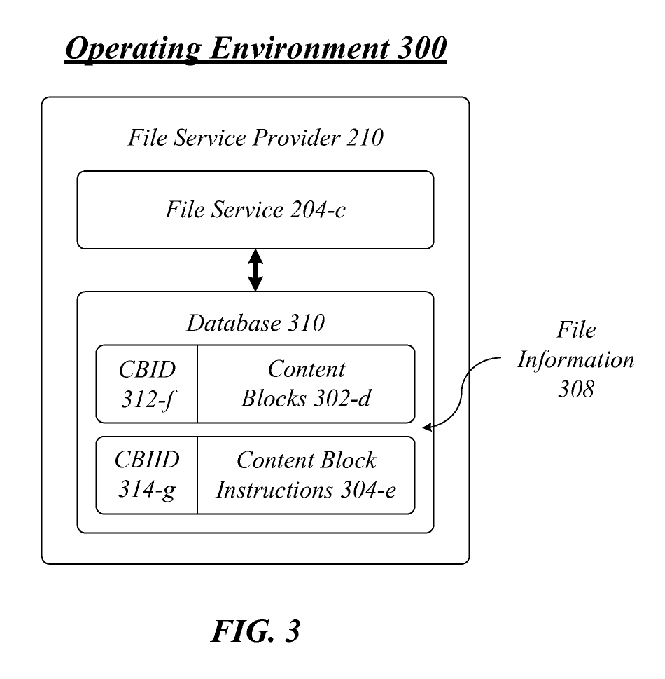

FIG. 3 illustrates an embodiment of an operational environment 300 for the file system 100. More particularly, FIG. 3 illustrates an exemplary file service 204-1 suitable for use with the file system 100.

The file services 204-c may be designed to manage various types and number of content blocks 302-d and content block instructions 304-e as stored in a database 310. As shown in FIG. 3, the service provider 210 may implement a file service 204-c. The file service 204-c may manage file information 308 for a virtual file 130. In one embodiment, the file information 308 may comprise any number and type of content blocks 302-d and content block instructions 304-e. The content blocks 302-d and content block instructions 304-e may be stored in a database 310. The database 310 may comprise any type of database, including a distributed database, a database management system (DBMS), a relational database management system (RDBMS) utilizing tables and relationships, and so forth.

One or more file services 204-c may also be configured to perform any number of file operations on one or more of the content blocks 302-d and content block instructions 304-e. For instance, in response to read requests, a file service 204-1 may receive requests to read the content blocks 302-d and content block instructions 304-e, retrieve the content blocks 302-d and content block instructions 304-e from the database 310, and return the content blocks 302-d and content block instructions 304-e to the requestor (e.g., virtual file application 120 and/or application 102). In response to write requests, a file service 204-2 may receive requests to modify the content blocks 302-d and content block instructions 304-e, modify the content blocks 302-d and content block instructions 304-e from the database 310, and return write confirmations for the content blocks 302-d and content block instructions 304-e to the requestor (e.g., virtual file application 120 and/or application 102). In those cases where there are no existing content blocks 302-d and content block instructions 304-e to modify, the file service 204-3 may store the content blocks 302-d and content block instructions 304-e as new file information utilizing various file creation techniques. These are merely a few examples of file operations, and the file services 204-c may be configured to provide other types of file services as previously described.

In one embodiment, the content blocks 302-d and content block instructions 304-e may be stored as separately addressable blocks of information within the database 310. In this case, each content block 302-d and content block instruction 304-e may be considered atomic units easily manipulated by the file services 204-c and the database 310. For instance, when the database 310 is implemented as a RDBMS, each of the content blocks 302-d and content block instructions 304-e may be stored as discrete chunks of information with assigned identifiers managed by the RDBMS, such as content block identifiers 312-f and content block instruction identifiers 314-g, respectively. In this case, the database 310 may store various content blocks 302-d and content block instructions 304-e for a virtual file 130 entirely as discrete pieces of datum, which may be located, accessed and processed utilizing the assigned identifiers. This high degree of granularity facilitates access, manipulation and processing of the content blocks 302-d and content block instructions 304-e, making a virtual file 130 highly dynamic and robust for use by the application 102.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

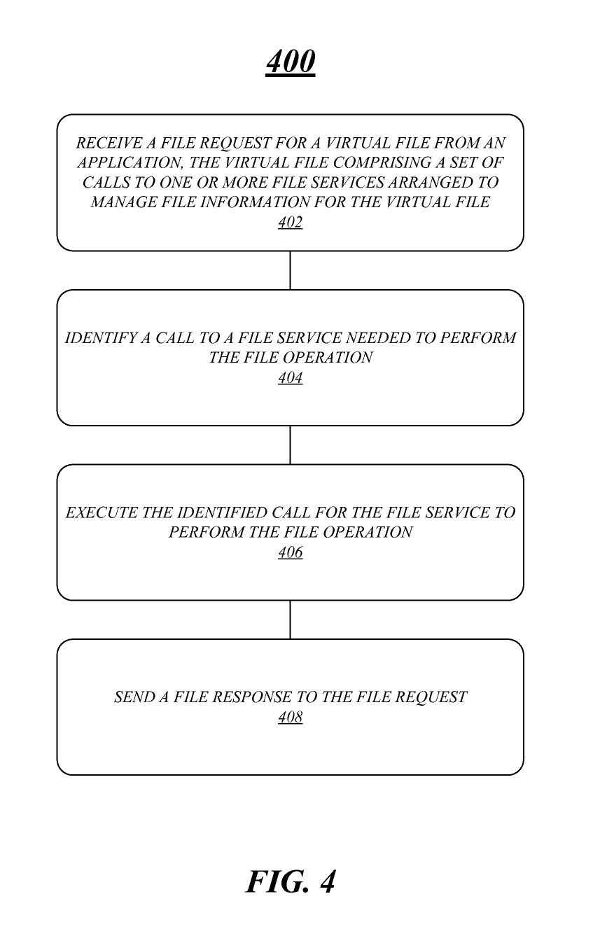

FIG. 4 illustrates one embodiment of a logic flow 400. The logic flow 400 may be representative of some or all of the operations executed by one or more embodiments described herein. For instance, the logic flow 400 may be implemented by the virtual file application 120 of the file system 100.

In the illustrated embodiment shown in FIG. 4, the logic flow 400 may receive a file request for a virtual file from an application, the virtual file comprising a set of calls to one or more file services arranged to manage file information for the virtual file at block 402. For example, the request handler component 122-1 may receive a file request 110 for a virtual file 130 from the application 102. The file request 110 may be for any given type of file operation, such as create a file, write a file, read a file, and so forth. The virtual file 130 may comprise, among other types of information, a set of calls 202-b to one or more file services 204-c arranged to manage file information 308 for the virtual file 130. In the embodiment, the file information 308 may comprise one or more content blocks 302-d associated with the virtual file 130 and managed by a file service 204-c. In the embodiment, the file information 308 may comprise one or more content block instructions 304-e associated with the virtual file 130 and managed by a file service 204-c.

The logic flow 400 may identify a call to a file service needed to perform the file operation at block 404. For example, the call handler component 122-2 may analyze the virtual file 130 to identify one or more calls 202-b to one or more file services 204-c needed to perform the requested file operation based on a given topology of calls 202-b to file services 204-c. For instance, assume the file request 110 is to write dirty portions of a document. The call handler component 122-2 may identify the calls 202-b for the relevant portions of the document that need to be written by a file service 204-c.

The logic flow 400 may execute the identified call for the file service to perform the file operation at block 406. For example, the call handler component 122-2 may execute the identified calls 202-b to the corresponding file services 204-c to perform the file operation indicated by the file request 110. Continuing with the previous example, the call handler component 122-2 may execute or invoke the appropriate calls 202-b to perform a dirty write to overwrite changed content blocks 302-d and/or content block instructions 304-e of the document in the database 310.

The logic flow 400 may send a file response to the file request at block 408. For example, the file manager component 122-3 may receive confirmation from the file service 204-c that a file operation has been completed via return values from executed calls 202-b, generate a file response 140 with the appropriate confirmations, and send the file response 140 to the application 102. In the case of dirty writes, the file manager component 122-3 may receive confirmation that a call 202-b to a file service 204-c has performed the write operations, and send a file response 140 to confirm completion of the dirty write operations.

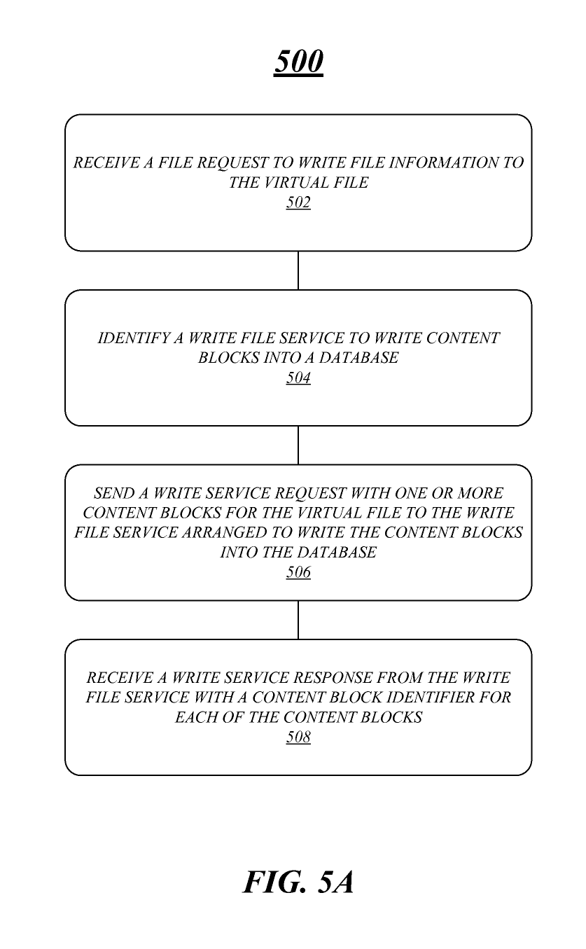

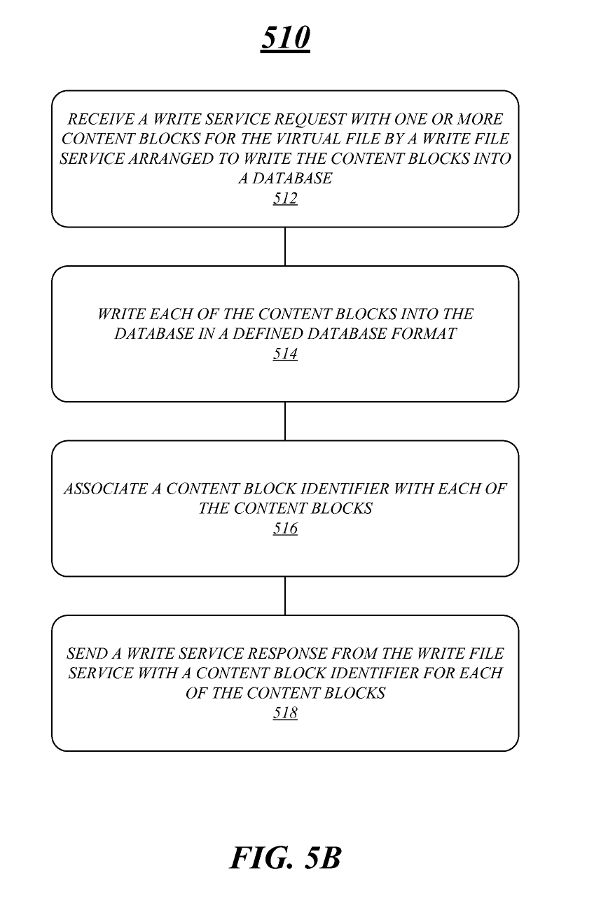

FIG. 5A illustrates an embodiment of a logic flow 500. The logic flow 500 may be representative of some or all of the operations executed by one or more embodiments described herein. For instance, the logic flow 500 may be implemented by the virtual file application 120 of the file system 100 to perform an exemplary write operation of the file system 100.

In the illustrated embodiment shown in FIG. 5A, the logic flow 500 may receive a file request to write file information to the virtual file at block 502. For example, the request handler component 122-1 may receive a file request 110 from the application 102 to write file information 308 to the virtual file 130. The file information 308 may comprise one or more content blocks 302-d and/or content block instructions 304-e.

The logic flow 500 may identify a write file service to write content blocks into a database at block 504. For example, the call handler component 122-2 may analyze the virtual file 130 to identify a call 202-1 to a write file service 204-1 configured to write content blocks 302-d into the database 310.

The logic flow 500 may send a write service request with one or more content blocks for the virtual file to the write file service arranged to write the content blocks into the database at block 506. The call handler component 122-2 may execute the call 202-1 to send a write service request with one or more content blocks 302-d for the virtual file 130 that need to be written to the database 310 to the write file service 204-1 arranged to write the content blocks 302-d into the database 310. The write file service 204-1 may be managed by the file service provider 210, which may be located locally or remotely from the virtual file application 120. The write file service 204-1 may then perform the write operations needed to write the content blocks 302-d into the database 310. When the content blocks 302-d are new content blocks 302-d, the write file service 204-1 may assign a content block identifier 312-f to each of the new content blocks 302-d added to the database 310. When the content blocks 302-d are existing content blocks 302-d (e.g., older versions), the write file service 204-1 may overwrite the existing content blocks 302-d utilizing the existing content block identifiers 312-f already assigned to each content block 302-d and used by the database 310.

The logic flow 500 may receive a write service response from the write file service with a content block identifier for each of the content blocks at block 508. The call handler component 122-2 may receive a write service response from the write file service 204-1 with a content block identifier 312-f for each of the content blocks 302-d. The content block identifiers 312-f may be used for future calls 202-b. In those cases where a content block 302-d already exists in the database 310 and has a content block identifier 312-f that has not changed, the content block identifier 312-f may be omitted from the write service response to reduce traffic overhead. The file manager component 122-3 may send a file response 140 with the write service response to the application 102 indicating write operations have been completed.

FIG. 5B illustrates an embodiment of a logic flow 510. The logic flow 510 may be representative of some or all of the operations executed by one or more embodiments described herein. For instance, the logic flow 510 may be implemented by the file service 204-1 of the file service provider 210 to perform a write operation in response to an executed call 202-1 of the virtual file 130. The logic flow 510 may, in some cases, minor the operations performed in the logic flow 500.

In the illustrated embodiment shown in FIG. 5B, the logic flow 510 may receive a write service request with one or more content blocks for the virtual file by a write file service arranged to write the content blocks into a database at block 512. For example, a write file service 204-1 may receive a write service request via a call 202-1 from the virtual file application 120 with one or more content blocks 302-d for the virtual file 130 by a write file service 204-1 arranged to write the content blocks 302-d into the database 310.

The logic flow 510 may write each of the content blocks into the database in a defined database format at block 514. For example, the write file service 204-1 may write each of the received content blocks 302-d into the database 310 in a defined database format used by the database 310.

The logic flow 510 may associate a content block identifier with each of the content blocks at block 516. For example, the write file service 204-1 may associate a content block identifier 312-f with each new content block 302-d when storing the received content blocks 302-d into the database 310. Existing content blocks 302-d may utilize the existing content block identifiers 312-f previously assigned by the file service 204-1.

The logic flow 510 may send a write service response from the write file service with a content block identifier for each of the content blocks at block 518. For example, the write file service 204-1 may send a write service response from the write file service 204-1 to the virtual file application and/or the application 102 as a return value to the call 202-1. The return value may include a content block identifier 312-f for each of the newly written content blocks 302-d. The application 102 may use the content block identifier 312-f for use with future invocations of calls 202-b.

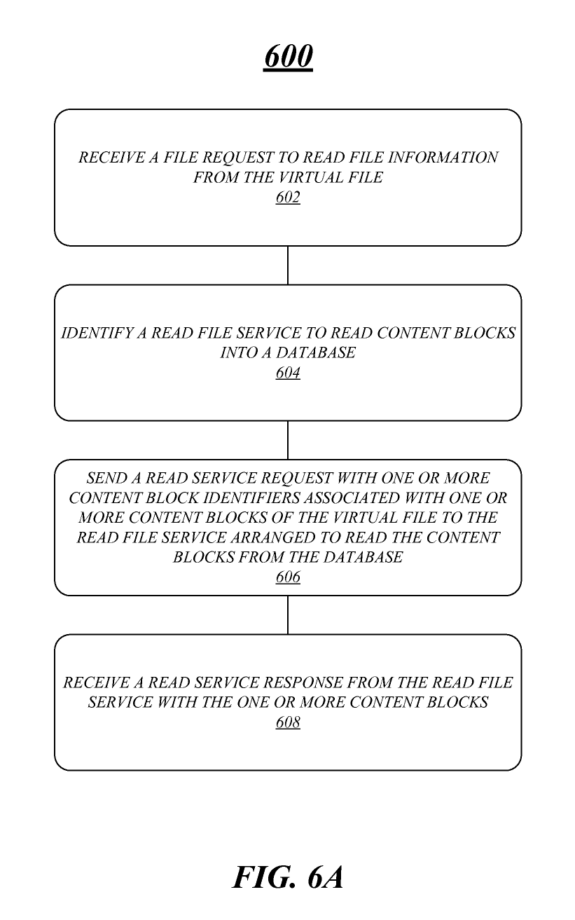

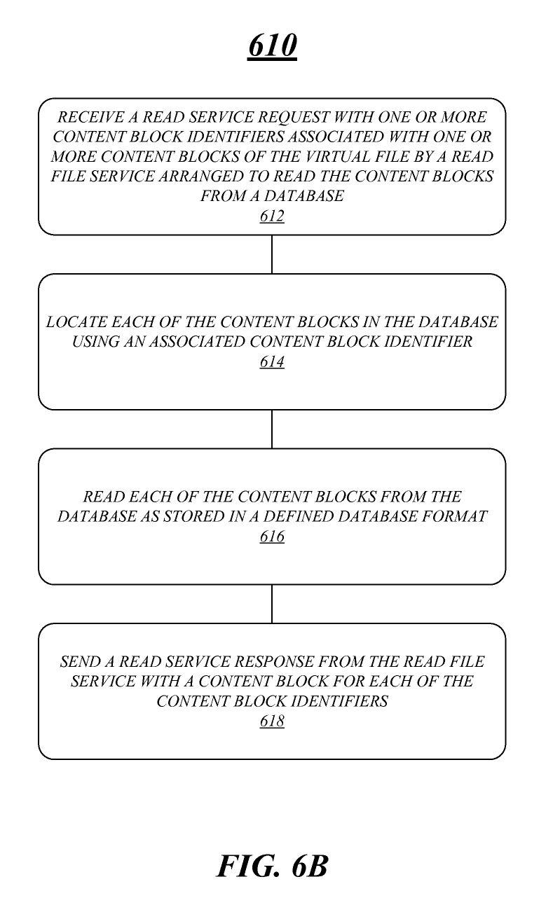

FIG. 6A illustrates an embodiment of a logic flow 600. The logic flow 600 may be representative of some or all of the operations executed by one or more embodiments described herein. For instance, the logic flow 600 may be implemented by the virtual file application 120 of the file system 100 to perform a read operation of the file system 100.

In the illustrated embodiment shown in FIG. 6A, the logic flow 600 may receive a file request to read file information from the virtual file at block 602. For example, the request handler component 122-1 may receive a file request 110 from the application 102 to read file information 308 from the virtual file 130. The file information 308 may comprise one or more content blocks 302-d and/or content block instructions 304-e.

The logic flow 600 may identify a read file service to read content blocks into a database at block 604. For example, the call handler component 122-2 may analyze the virtual file 130 to identify a read file service 204-2 to read one or more content blocks 302-d from the database 310.

The logic flow 600 may send a read service request with one or more content block identifiers associated with one or more content blocks of the virtual file to the read file service arranged to read the content blocks from the database at block 606. For example, the call handler component 122-2 may execute a call 202-2 with one or more input values to send a read service request with one or more content block identifiers 312-f associated with one or more content blocks 302-d of the virtual file 130 to the read file service 204-2 arranged to read the content blocks 302-d from the database 310.

The logic flow 600 may receive a read service response from the read file service with the one or more content blocks at block 608. For example, the call handler component 122-2 may receive a read service response from the read file service 204-2 with the one or more content blocks 302-d. The file manager component 122-3 may send a file response 140 to the application 102 with the read service response. The application 102 may then present the content blocks 302-d on an electronic display for a user of the application 102.

FIG. 6B illustrates an embodiment of a logic flow 610. The logic flow 610 may be representative of some or all of the operations executed by one or more embodiments described herein. For instance, the logic flow 610 may be implemented by the read file service 204-2 of the file service provider 210 to perform a read operation in response to an executed call 202-2 of the virtual file 130. The logic flow 610 may, in some cases, minor the operations of the logic flow 600.

In the illustrated embodiment shown in FIG. 6B, the logic flow 610 may receive a read service request with one or more content block identifiers associated with one or more content blocks of the virtual file by a read file service arranged to read the content blocks from a database at block 612. For instance, the read file service 204-2 may receive a read service request from the virtual file application 120 via the call 202-2. The read service request may include one or more content block identifiers 312-f associated with one or more content blocks 302-d of the virtual file 130.

The logic flow 610 may locate each of the content blocks in the database using an associated content block identifier at block 614. For instance, the file service 204-2 may be arranged to access the database 310 to locate the content blocks 302-d utilizing the content block identifiers 312-f.

The logic flow 610 may read each of the content blocks from the database as stored in a defined database format at block 616. The file service 204-2 may be arranged to retrieve the content blocks 302-d from the database 310 utilizing the content block identifiers 312-f.

The logic flow 610 may send a read service response from the read file service with a content block for each of the content block identifiers at block 618. For example, the read file service 204-2 may send a read service response with a content block 302-d for each of the content block identifiers 312-f to the virtual file application 120. The file manager component 122-3 may send a file response 140 to the application 102 with the read service response. The application 102 may then present the content blocks 302-d on an electronic display for a user of the application 102.

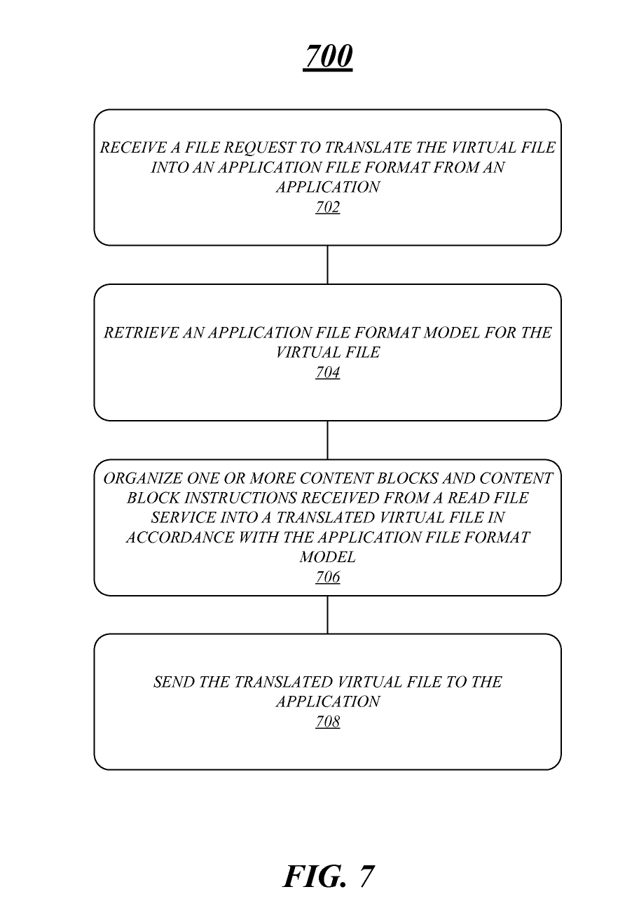

FIG. 7 illustrates an embodiment of a logic flow 700. The logic flow 700 may be representative of some or all of the operations executed by one or more embodiments described herein. For instance, the logic flow 700 may be implemented by the virtual file application 120 of the file system 100 to perform a file translation operation of the file system 100 for a given application 102.

In the illustrated embodiment shown in FIG. 7, the logic flow 700 may receive a file request to translate the virtual file into an application file format from an application at block 702. The file translation component 122-4 may receive a file request 110 to translate the virtual file 130 into an application file format from the application 102.

The logic flow 700 may retrieve an application file format model for the virtual file at block 704. The file translation component 122-4 may retrieve an application file format model for the virtual file 130 from a datastore accessible by the virtual file application 120.

The logic flow 700 may organize one or more content blocks and content block instructions received from a read file service into a translated virtual file in accordance with an application file format model at block 706. For instance, the file translation component 122-4 may organize one or more content blocks 302-d and content block instructions 304-e received from a read file service into a translated virtual file in accordance with an application file format model. The file translation component 122-4 may then store the content blocks 302-d and content block instructions 304-e into a translated virtual file. In one embodiment, a translated virtual file may comprise a conventional electronic file known and utilized by the application 102.

The logic flow 700 may send the translated virtual file to the application at block 708. For instance, the file manager component 122-3 may send the translated virtual file to the application 102. Alternatively, the file manager component 122-3 may send a name and location for the translated virtual file to the application 102 to conserve bandwidth.

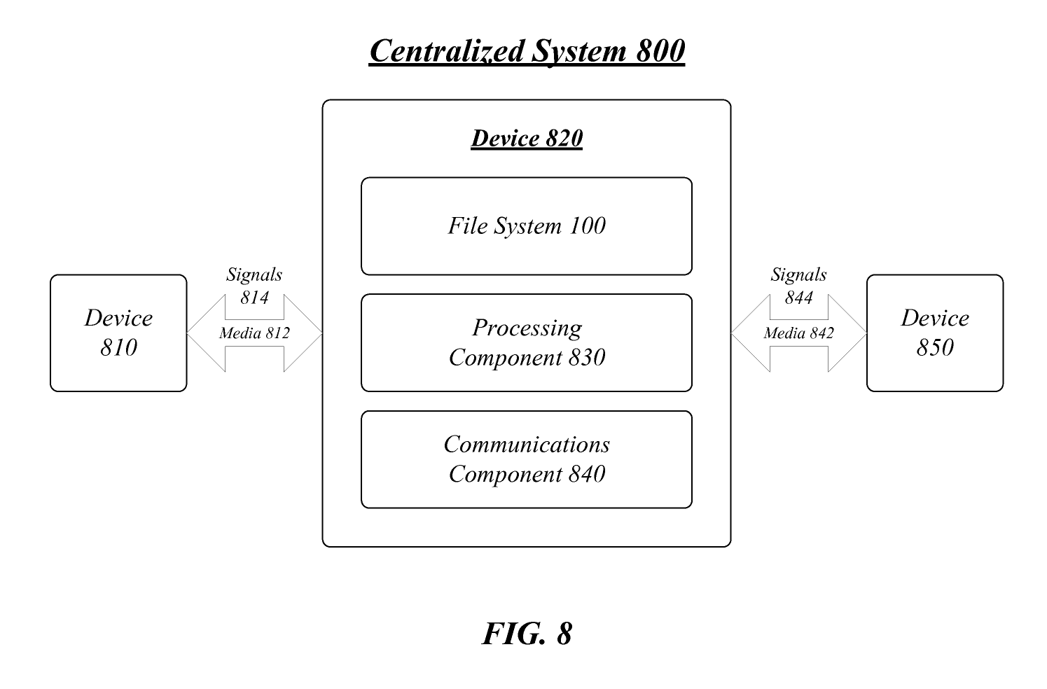

FIG. 8 illustrates a block diagram of a centralized system 800. The centralized system 800 may implement some or all of the structure and/or operations for the file system 100 in a single computing entity, such as entirely within a single device 820.

The device 820 may comprise any electronic device capable of receiving, processing, and sending information for the file system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the file system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the file system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices 810, 850 over a communications media 812, 842, respectively, using communications signals 814, 844, respectively, via the communications component 840. The devices 810, 850 may be internal or external to the device 820 as desired for a given implementation.

In one embodiment, the file system 100 may be entirely implemented in the device 820, including the virtual file application 120 and the file service provider 210. In one embodiment, the portions of the file system 100 may be distributed across all three devices 810, 820, and 850. For instance, the application 102 may be implemented in the device 810, the virtual file application 120 may be implemented in the device 820, and the file service provider 210 may be implemented in the device 850. Other configurations and combinations may be implemented as well.

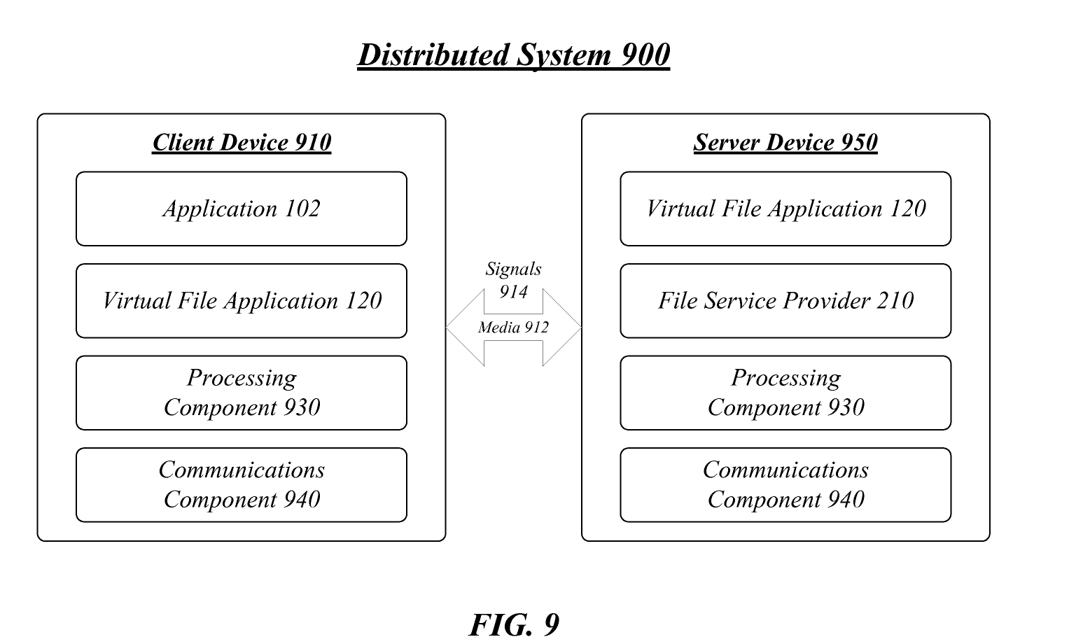

FIG. 9 illustrates a block diagram of a distributed system 900. The distributed system 900 may distribute portions of the structure and/or operations for the file system 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a server device 950. In general, the client device 910 and the server device 950 may be the same or similar to the client device 820 as described with reference to FIG. 8. For instance, the client device 910 and the server device 950 may each comprise a processing component 930 and a communications component 940 which are the same or similar to the processing component 830 and the communications component 840, respectively, as described with reference to FIG. 8. In another example, the devices 910, 950 may communicate over a communications media 912 using communications signals 914 via the communications components 940.

The client device 910 may comprise or employ one or more client programs that operate to perform various methodologies in accordance with the described embodiments. In one embodiment, for example, the client device 910 may implement some or all of the file system 100, such as the application 102 and/or the virtual file application 120, for example.

The server device 950 may comprise or employ one or more server programs that operate to perform various methodologies in accordance with the described embodiments. In one embodiment, for example, the server device 950 may implement some or all of the file system 100, such as the virtual file application 120 and/or the file service provider 210.

In one embodiment, the client device 910 may execute the application 102 and the virtual file application 120 to access file services 204-c provided by the file service provider 210 for virtual file operations executed by the server device 950. In one embodiment, the client device 910 may execute the application 102, while the virtual file application 120 and the file services 204-c provided by the file service provider 210 for virtual file operations are executed by the server device 950. Other configurations and combinations may be implemented as well.

In one embodiment, the client device 910 and the server device 950 may be arranged in a cloud computing model, where the entire file system 100 is implemented in the server device 950, and the client device 910 implements a browser or thin client to access features and/or services provided by the file system 100. The server device 950 may be accessed by a thin-client application and any associated thin-client hardware, including, but not limited to, ultra-thin client, web thin client, and mobile thin client implementations, or through a web browser user interface, including without limitation Microsoft® Internet Explorer®, Mozilla® Firefox®, Apple® Safari®, and Google Chrome™ browser applications.

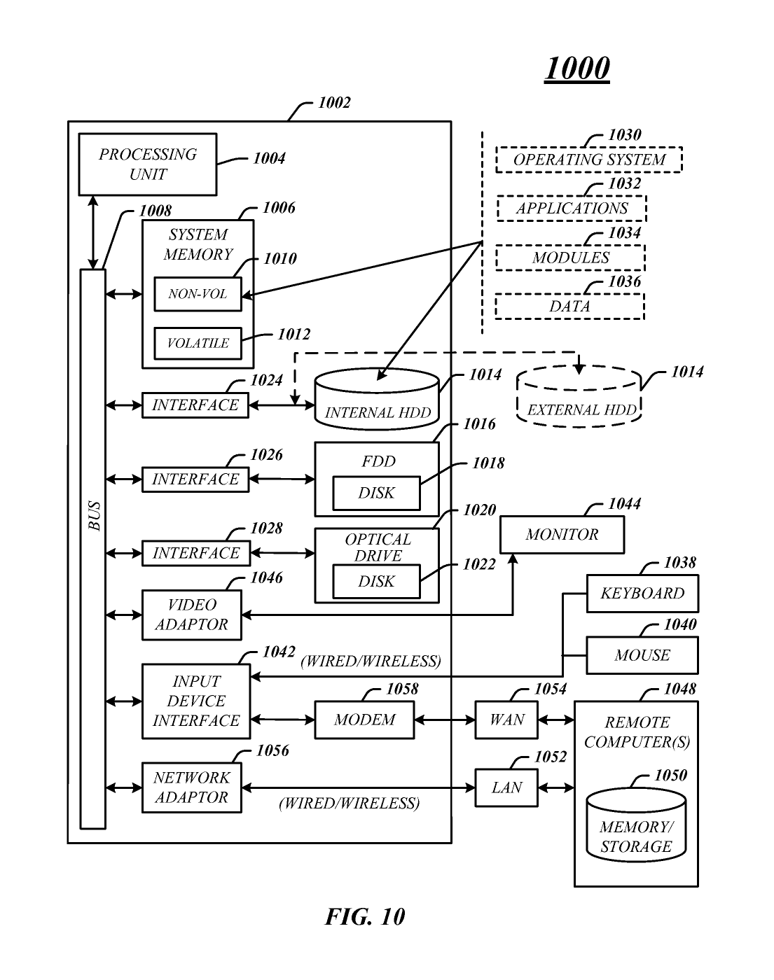

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the file system 100.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

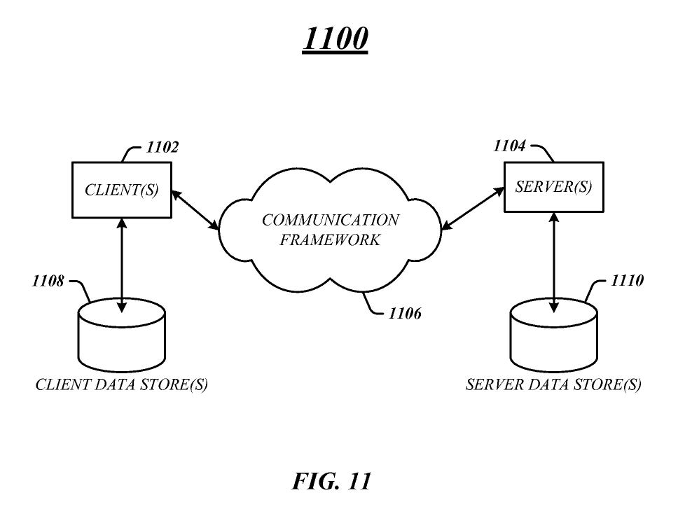

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 may implement the client device 910. The servers 1104 may implement the server device 950. The clients 1102 and the servers 1104 are operatively connected to one or more respective client data stores 1108 and server data stores 1110 that can be employed to store information local to the respective clients 1102 and servers 1104, such as cookies and/or associated contextual information.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth needed by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
receiving a file request for a virtual file from an application, the virtual file comprising a set of calls to one or more file services arranged to manage file information for the virtual file;
identifying a call to a file service needed to perform the file operation;
executing the identified call for the file service to perform the file operation; and
sending a file response to the file request.

2. The computer-implemented method of claim 1, wherein the file information comprises a content block associated with the virtual file.

3. The computer-implemented method of claim 1, wherein the file information comprises content object instructions for a content block associated with the virtual file.

4. The computer-implemented method of claim 1, comprising receiving a file request to write file information to the virtual file.

5. The computer-implemented method of claim 1, comprising:
identifying a write file service to write content blocks into a database;
sending a write service request with one or more content blocks for the virtual file to the write file service arranged to write the content blocks into the database; and
receiving a write service response from the write file service with a content block identifier for each of the content blocks.

6. The computer-implemented method of claim 1, comprising:
receiving a write service request with one or more content blocks for the virtual file by a write file service arranged to write the content blocks into a database;
writing each of the content blocks into the database in a defined database format;
associating a content block identifier with each of the content blocks; and
sending a write service response from the write file service with a content block identifier for each of the content blocks.

7. The computer-implemented method of claim 1, comprising receiving a file request to read file information from the virtual file.

8. The computer-implemented method of claim 1, comprising:
identifying a read file service to read content blocks into a database;
sending a read service request with one or more content block identifiers associated with one or more content blocks of the virtual file to the read file service arranged to read the content blocks from the database; and
receiving a read service response from the read file service with the one or more content blocks.

9. The computer-implemented method of claim 1, comprising:
receiving a read service request with one or more content block identifiers associated with one or more content blocks of the virtual file by a read file service arranged to read the content blocks from a database;
locating each of the content blocks in the database using an associated content block identifier;
reading each of the content blocks from the database as stored in a defined database format; and
sending a read service response from the read file service with a content block for each of the content block identifiers.

10. The computer-implemented method of claim 1, comprising receiving a file request to translate the virtual file into an application file format from an application.

11. The computer-implemented method of claim 1, comprising retrieving an application file format model for the virtual file.

12. The computer-implemented method of claim 1, comprising organizing one or more content blocks and content block instructions received from a read file service into a translated virtual file in accordance with an application file format model.

13. An apparatus, comprising:
a processor circuit; and
a virtual file application operative on the processor circuit to manage file operations for a virtual file, the virtual file comprising a set of calls to one or more file services arranged to manage file information for the virtual file, the file information comprising a content block or content block instructions for a content block associated with the virtual file.

14. The apparatus of claim 13, the virtual file application comprising a request handler component operative to manage file requests and file responses for the virtual file.

15. The apparatus of claim 13, the virtual file application comprising a call handler component operative to manage the set of calls for the virtual file.

16. The apparatus of claim 13, the virtual file application comprising a file manager component operative to perform file operations for the virtual file.

17. The apparatus of claim 13, the virtual file application comprising a file translation component operative to translate file information for the virtual file into an application file format.

18. At least one article of manufacture comprising a computer readable storage medium containing instructions that when executed cause a system to:
receive a file request for a virtual file comprising a set of calls to one or more file services arranged to manage file information for the virtual file;
execute one or more calls for the file service to receive file information;
perform the file operation for the virtual file with the received file information in response to the file request.

19. The article of manufacture of claim 18, comprising instructions that when executed enable the system to perform a write file request or a read file request.

20. The article of manufacture of claim 18, wherein the file information comprises a content block associated with the virtual file or content block instructions for a content block associated with the virtual file.
